(19) United States
(12) Patent Application Publication
(10) Pub. No.: US 2011/0154211 A1
(43) Pub. Date: Jun. 23, 2011

(54) APPARATUS AND METHOD FOR PROVIDING INFORMATION OF TERMINAL FOR SESSION MOBILITY BETWEEN TERMINALS

(75) Inventors: Cho-Rong YU, Daejeon-si (KR); Hwa-Suk KIM, Daejeon-si (KR); Kee-Seong CHO, Daejeon-si (KR)

(73) Assignee: Electronics and Telecommunications Research Institute, Daejeon (KR)

(21) Appl. No.: 12/878,405

(22) Filed: Sep. 9, 2010

(30) Foreign Application Priority Data
Dec. 18, 2009 (KR) 10-2009-0127294

(51) Int. Cl. G06F 15/177; G06F 3/01

(52) U.S. Cl. 715/737; 709/220

(57) ABSTRACT

Provided are an apparatus and method for providing information about terminals allowing session mobility. A target terminal list is configured by locating terminals having higher possibilities for session mobility to locations having higher session mobility priorities on the target terminal list to reconfigure the target terminal list, the reconfigured target terminal list is transmitted to a terminal in which a session is currently being executed, and a terminal to which the session is to be moved is selected from the target terminal list. Accordingly, efficiency of session mobility is ensured.

### CROSS-REFERENCE TO RELATED APPLICATION

This application claims the benefit under 35 U.S.C. §119(a) of a Korean Patent Application No. 10-2009-0127294, filed on Dec. 18, 2009, the entire disclosure of which is incorporated herein by reference for all purposes.

### BACKGROUND

1. Field

The following description relates to session mobility, and more particularly, to an apparatus and method for providing information of terminals allowing session mobility, in order for a user to select a suitable one from among a plurality of target terminals allowing session mobility and move a session being currently executed to the selected terminal.

2. Description of the Related Art

Session mobility means a process of moving a multimedia service session being currently executed to a target network or terminal when a change occurs in an access network or device. Continuing to provide services without disruption during session transfer is called service continuity.

The 3rd Generation Partnership Project (3GPP) Release-8 has standardized a method of ensuring service continuity between access networks among methods of ensuring multimedia service continuity, and recently, the 3GPP Release-9 is standardizing a method of ensuring service continuity between terminals.

Various scenarios have been introduced in association with multimedia service continuity. The scenarios include PS-CS continuity dealing with the case where a media session on a CS domain moves to a PS network or vice versa, PS-PS continuity dealing with session mobility between PS networks, terminal continuity dealing with supporting continuity when multimedia components move between a user's different terminals, and partial session mobility supporting movement of all or some of media components.

When a session moves between access networks, a session mobility request including information about a network interface to which the session will move, among two or more network interfaces which a terminal possesses under the same terminal environment, is transmitted to an application server AS.

The application server AS performs a session mobility procedure according to the information about the network interface to which the session will move included in the session mobility request. Here, since the information about the network interface is network interface information under the same terminal environment, it can be considered information that the terminal already knows, and there is no need to provide it to the terminal before the session mobility request is issued.

However, when a session is moved between terminals, a current terminal must acquire information about another terminal to which a session being executed by the current terminal is to be moved and then transmits a session mobility request including the information about the other terminal to the application server AS.

In order for a user managing a plurality of terminals to move a session, the user selects a target terminal to which the session will move before issuing a session mobility request. Accordingly, the session moves only to the target terminal selected by the user with no consideration about terminals having high possibility of session mobility.

### SUMMARY

The following description relates to a technique of allowing a user to select a terminal to which a session being currently executed is suitable to be moved by locating terminals having higher possibilities of session mobility to locations having higher session mobility priorities on a target terminal list to reconfigure the target terminal list and transmitting the reconfigured target terminal list to a terminal in which the session is currently being executed.

When a terminal currently executing a session selects a target terminal to which the session is to be moved from the target terminal list, a session mobility request message to which information about the selected target terminal is reflected is transmitted to a session mobility application server.

Also, the target terminal list is provided when the user registers a new terminal or de-registers an existing terminal, when an event regarding registration or de-registration of a terminal is received from a network core, when a current terminal currently executing a session is within a predetermined distance from the target terminal by comparing location information of the current terminal, collected at regular time intervals, with location information on each target terminal on the target terminal list, or when a push request is transmitted to a terminal currently executing a session even when there is no user's request.

Also, information about terminals allowing session mobility may be provided when a terminal currently executing a session requests a list of target terminals allowing session mobility.

In one general aspect, there is provided an apparatus for providing information about terminals allowing session mobility when a session is moved between terminals, including: a terminal information manager to maintain and manage information about terminals existing on a network; and a target terminal estimator to assign, when a session of a current terminal in which a session is currently being executed is moved to another terminal among the terminals existing on the network, weights to the terminals existing on the network based on relevancy to the current terminal using the information about the terminals, and to select a terminal to which a higher weight has been assigned as a terminal having higher possibility for session mobility.

The information about the terminals may include network information of the terminals, location information of the terminals, and information indicating that each terminal has been registered on the network or that each terminal has been de-registered from the network.

The target terminal selector may include: a terminal weight calculator to assign the weights to the terminals existing on the network based on the relevancy to the current terminal, using the information about the terminals; and a target terminal list configuring unit to configure a list of target terminals to which the session of the current terminal is to be moved, according to the weights.

The apparatus may further include: a terminal weight DB to store, when the terminal having the high possibility of session mobility is selected, information of the terminal in the form of a terminal weight table in which the information of the terminal is mapped to a weight; and a target terminal selector to provide a list of target terminals that have been determined to have high possibilities of session mobility by the target terminal estimator and a list of target terminals stored in the terminal weight DB, and to allow a target terminal to which the session of the current terminal is to be moved to be selected from the list of target terminals.

The target terminal estimator may assign the weights to the terminals, when the terminals existing on the network have network information similar to that of the terminal in which the session is currently being executed, when the terminals existing on the network are determined to be within a predetermined distance from the terminal in which the session is currently being executed, based on the location information of the terminals, or when the terminals existing on the network are newly registered, and the target terminal estimator may select terminals determined to have high weights as terminals having high possibility of session mobility.

When a terminal registered on the network is de-registered while assigning the weights to the terminals, the target terminal estimator may delete information about the de-registered terminal and selects and provide a terminal having a high weight as a terminal having high possibility of session mobility.

The terminal weight DB may store information of the selected terminal in the form of a terminal weight table in which user identification information of the terminal, network identification information of the terminal and identification information of the terminal are mapped to a weight.

The target terminal selector may assign the weights to the terminals existing on the network when the terminal in which the session is currently being executed requests a list of target terminals to which the session is to be moved or when a terminal weight table for the terminal in which the session is currently being executed is updated.

When a terminal existing on the network is a newly registered terminal, the target terminal estimator may assign a weight to the terminal.

When a predetermined time elapses after the terminal having the high possibility of session mobility is selected, the target terminal estimator may again assign weights to the terminals existing on the network using the network information and the location information of the terminals.

In another general aspect, there is provided a method of providing information about terminals allowing session mobility when a session is moved between terminals, including: assigning weights to terminals existing on the network based on relevancy to a current terminal in which a session is currently being executed, using information about the current terminal and information about the terminals existing on the network; configuring a list of target terminals by arranging the terminals to which the weights have been assigned in a descending order of the weights; providing the list of target terminals to the terminal in which the session is currently being executed; and providing the list of target terminals in the current terminal in which the session is currently being executed.

According to the above-described aspects, when an application server determines that possibility of session mobility is high, based on location information of a terminal currently executing a session, before receiving a request for session mobility between terminals, the application server receives an event informing that the same user's terminal is registered or de-registered, creates a session mobility terminal list based on the event, estimates a terminal having high possibility for session mobility, relocates the terminal to a location having high session mobility priority on the session mobility terminal list to reconfigure the session mobility terminal list and then provides the reconfigured session mobility terminal list to the terminal currently executing the session.

Also, by providing the list of terminals allowing session mobility, possibilities for session mobility of target terminals to which the session can be moved are estimated in consideration of location information, network information, and registration and de-registration information of the terminals, and information about a terminal having high possibility for session mobility is received from the results of the estimation, which contributes to efficiency enhancement of session mobility.

Furthermore, by monitoring information about terminals periodically as well as when a request for a list of target terminals allowing session mobility is received and when an event for registration or de-registration of a terminal is generated, the list of target terminals allowing session mobility is transmitted to a terminal in which a session is currently being executed, when a change is sensed from the results of the monitoring, so that session mobility is recommended even to a terminal which has issued no session mobility request.

In addition, by performing session mobility while transmitting a session mobility request message to a session mobility application server when a target terminal is selected from a list of target terminals allowing session mobility, more convenient session mobility is achieved.

Other features and aspects will be apparent from the following detailed description, the drawings, and the claims.

### BRIEF DESCRIPTION OF THE DRAWINGS

FIG. 1 is a flowchart illustrating an example of a method for session mobility between terminals.

FIG. 2 is a diagram illustrating an example of an apparatus for providing information about target terminals allowing session mobility.

FIG. 3 illustrates an example of a terminal weight table that is stored in a terminal weight database (DB).

FIG. 4 is a flowchart illustrating an example of a method of calculating weights in the apparatus for providing information about target terminals allowing session mobility.

FIG. 5 is a flowchart illustrating an example of a method of calculating weights for target terminals in consideration of location change information of the target terminals to configure a target terminal list.

FIG. 6 is a flowchart illustrating an example of a method of configuring a target terminal list according to a target terminal list request from a terminal in which a session is currently being executed.

FIGS. 7a to 7b are flowcharts illustrating an example of a method of reconfiguring a target terminal list when an event is generated while calculating weights for target terminals.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

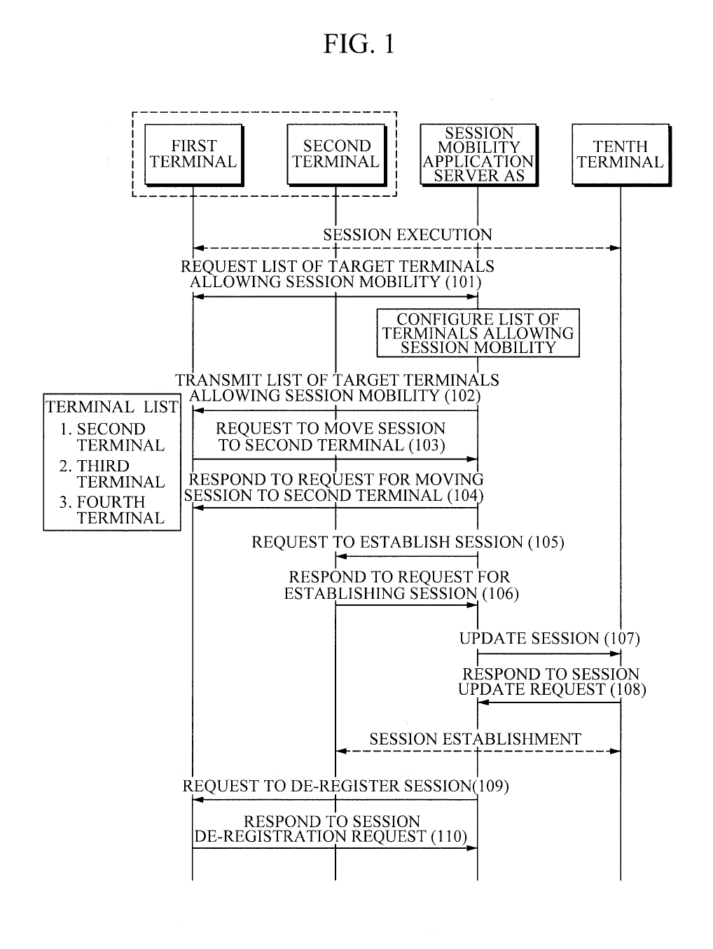

FIG. 1 is a flowchart illustrating an example of a method for session mobility between terminals.

FIG. 1 corresponds to the case where a session is moved from a first terminal to a second terminal through a session mobility application server AS

When sessions of the first and tenth terminals are currently being executed, the first terminal requests the session mobility application server AS to transmit a list of target terminals allowing session mobility (operation 101). The session mobility application server AS that has received the request for the target terminal list selects terminals having high possibilities of session mobility with respect to the first terminal from among a plurality of terminals existing on a network, thus configuring a target terminal list consisting of the selected terminals. Thereafter, the session mobility application server AS transmits the target terminal list to the first terminal (operation 102).

Then, the first terminal selects a terminal (a second terminal in the current example) most suitable for session mobility from the target terminal list and requests the session mobility application server AS to move the current session of the first terminal to the second terminal (operation 103).

The session mobility application server AS responds to the request from the first terminal (operation 104) and requests the second terminal to establish a session (operation 105).

When the second terminal responds to the request for establishing the session (operation 106), the session mobility application server AS requests the tenth terminal to update a session (operation 107), receives a response to the session update request from the tenth terminal (operation 108) and then establishes a session between the second terminal and the tenth terminal.

After the session establishment between the second terminal and the tenth terminal is complete, the session mobility application server AS requests the first terminal to de-register the session (operation 109) and terminates session mobility when receiving a response to the session de-registration request from the first terminal (operation 110).

A method of selecting terminals having high possibilities of session mobility may include a method of collecting location information of terminals currently executing sessions at regular time intervals to assign session mobility priorities to terminals located close to the terminals currently executing the sessions, a method of assigning session mobility priorities to terminals that provide a network type similar to that provided by a terminal currently executing a session, a method of assigning a session mobility priority to a newly registered terminal, and so on. The method of selecting terminals having high possibilities of session mobility may extend depending on information acquirable by a session mobility application server. Details for this will be described later.

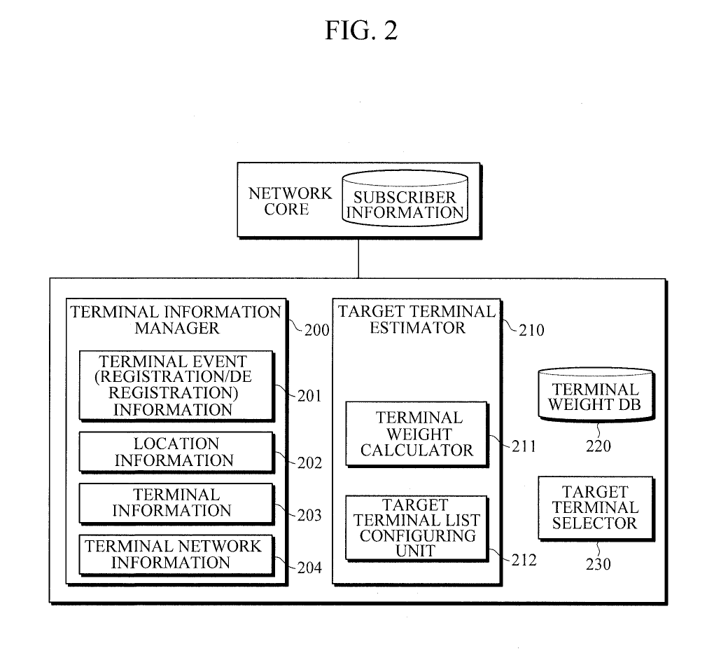

FIG. 2 is a diagram illustrating an example of an apparatus for providing information about target terminals allowing session mobility.

Referring to FIG. 2, the apparatus for providing information about target terminals includes a terminal information manager 200, a target terminal estimator 210, a terminal weight database (DB) 220 and a target terminal selector 230.

The terminal information manager 200 stores terminal event (registration/de-registration) information 201, location information 202, terminal information 203 and terminal network information 204, and the target terminal estimator 210 for estimating possibilities of session mobility may include a terminal weight calculator 211 and a target terminal list configuring unit 212.

In addition, the apparatus for providing information about target terminals may include a terminal weight DB 220 which stores weights to be assigned to terminals and a target terminal selector 230 for transmitting a session mobility target terminal list to terminals and selecting a terminal to which a session is to be moved.

The terminal event information 201 is information about events in which a terminal is de-registered or a new terminal is registered under the control of the same user. The terminal information manager 200 communicates with a network core in order to acquire location information of a specific terminal and include the acquired location information in the location information 202. Likewise, the terminal information manager 200 communicates with the network core in order to acquire a list of terminals that is under the control of the same user and information about the individual terminals. The terminal network information 204 is information about characteristics of a network where terminals exist.

The terminal weight calculator 212 is in charge of a function of assigning weights to terminals according to network information, location information, registration and de-registration information of the terminals, and storing the weights for the individual terminals, in order to estimate possibilities of session mobility with respect to the terminals. The target terminal list configuring unit 211 locates terminals having higher weights to locations having higher session mobility priorities on a target terminal list to reconfigure the target terminal list.

The target terminal list and the information about the individual terminals are transmitted to the terminal in which a session is currently being executed and then used by the terminal when the terminal issues a session mobility request.

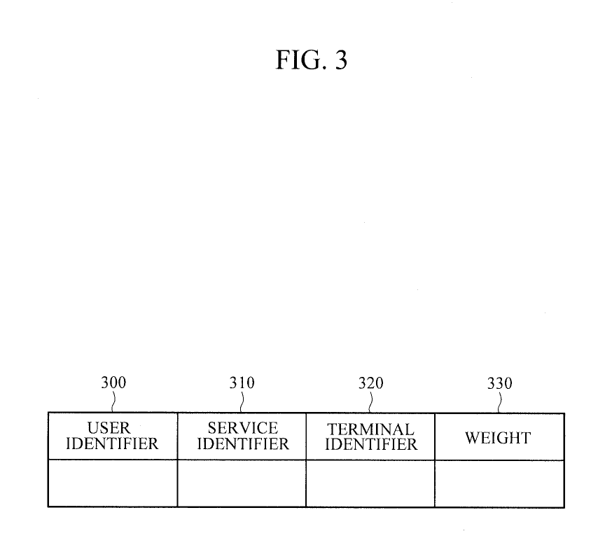

FIG. 3 illustrates an example of a terminal weight table 212 that is stored in the terminal weight DB 220.

As described above, the terminal weight calculator 212 assigns weights to terminals according to network information, location information, registration and de-registration information of the terminals, in order to estimate possibilities of session mobility with respect to the terminals, wherein the weights for the individual terminals may be stored in the form of a terminal weight table illustrated in FIG. 3.

The terminal weight table may include user identification information 300, service (network) identifier information 310, terminal identification information 320 and weights for terminals 330. The terminal weight table is used to configure a target terminal list.

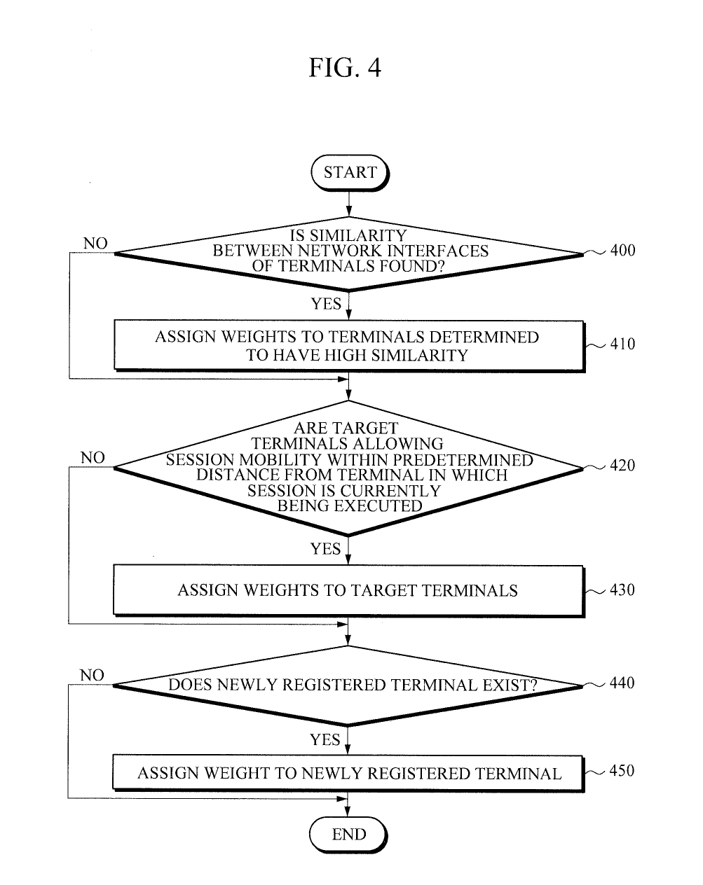

FIG. 4 is a flowchart illustrating an example of a method of calculating weights in the apparatus for providing information about target terminals allowing session mobility.

First, a weight for each terminal is calculated to configure a list of target terminals allowing session mobility.

Then, similarity is compared between network interfaces of a terminal in which a session is currently being executed and of terminals that exist on a network, and weights of terminals determined to have high similarity increase (operations 400 and 410). Then, location information of the terminal in which the session is currently being executed and target terminals allowing session mobility is acquired and weights of terminals that are within a predetermined distance from the terminal in which the session is currently being executed also increase (operations 420 and 430).

Also, when a new terminal is registered, the terminal is added to the target terminal list and a weight of the newly registered terminal increases (operations 440 and 450). The weight calculating method illustrated in FIG. 4 has been designed under the assumption that a possibility of moving a session to a new terminal registered during execution of a session is high.

Information capable of being used to calculate weights may extend to information acquirable on the network other than the above-described information and accordingly the weight calculating method may extend to various methods depending on acquirable information.

The calculated weights and related information are stored in a terminal weight storage. The target terminal list configuring unit 211 locates terminals having higher weights to locations having higher session mobility priorities and sequentially locates terminals having the same weight and related information, thereby reconfiguring a target terminal list.

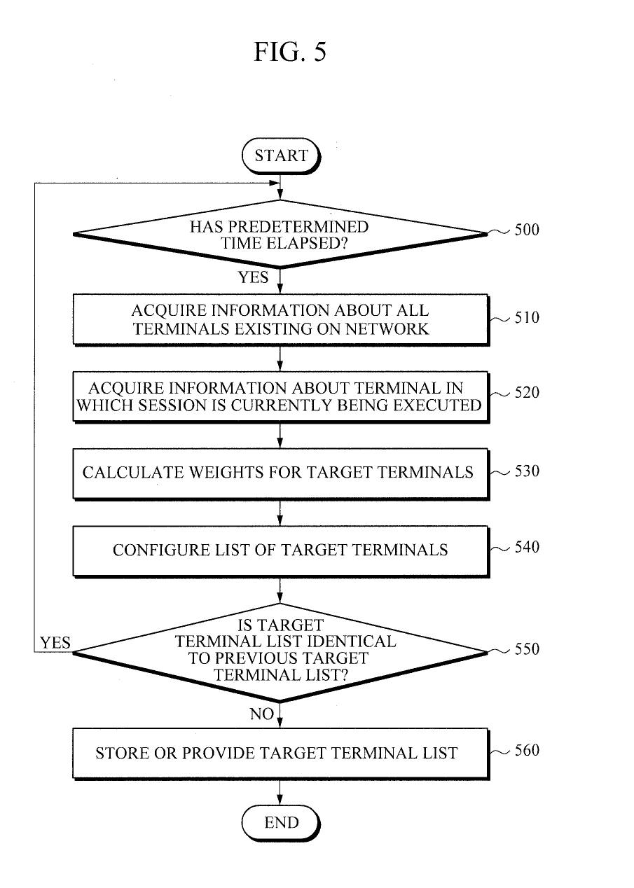

FIG. 5 is a flowchart illustrating an example of a method of calculating weights for terminals in consideration of location change information of the terminals to configure a target terminal list.

When a time set in advance in a system elapses after a target terminal list is configured or while weights for terminals are calculated (operation 500), information about all terminals that exist on a network is again acquired (operation 510).

Then, information about a terminal in which a session is currently being executed among the terminals is acquired (operation 520), so that weights for target terminals with respect to the terminal in which the session is currently being executed are calculated (operation 530).

Then, a target terminal list is reconfigured by locating terminals having higher weights to locations having higher session mobility priorities on the target terminal list and sequentially locating terminals having the same weight (operation 540). Then, the reconfigured target terminal list is compared with the previous target terminal list (operation 550). If the reconfigured target terminal list is different from the previous target terminal list, the previous target terminal list is updated to the reconfigured target terminal list and then stored. Then, the reconfigured target terminal list is provided to the terminal in which the session is currently being executed (operation 560).

The weight calculating method illustrated in FIG. 5 may be based on a message push mechanism which compares location information of a terminal in which a session is currently being executed with location information of terminals included in a target terminal list at regular time intervals, and transmits the target terminal list to the terminal in which the session is currently being executed when a terminal that is within a predetermined distance from the terminal in which the session is currently being executed is found.

In order to avoid any unnecessary notification, a function of storing the latest target terminal list is needed, and if the result of the comparison indicates that the latest target terminal list is identical to the previous target terminal list, the latest target terminal list is ignored. A time at which the target terminal list is provided according to the message push mechanism may be arbitrarily set and may depend on information acquirable on a network.

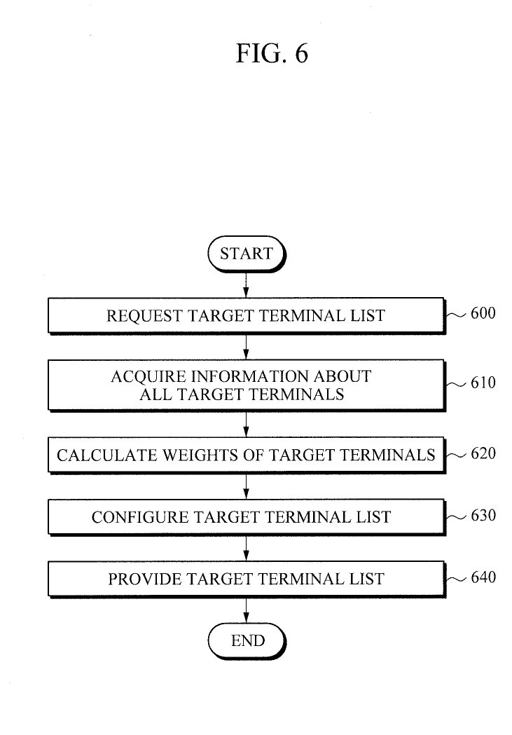

FIG. 6 is a flowchart illustrating an example of a method of configuring a target terminal list according to a target terminal list request from a terminal in which a session is currently being executed.

When a target terminal list request is issued from a terminal in which a session is currently being executed (operation 600), information about all target terminals on a network is acquired (operation 610) and weights of the target terminals are calculated with respect to the terminal in which the session is currently being executed (operation 620).

Then, a target terminal list is configured by locating terminals having higher weights to locations having higher session mobility priorities on the target terminal list and sequentially locating terminals having the same weight (operation 630) and the target terminal list is provided to the terminal in which the session is currently being executed (operation 640), in order to support session mobility.

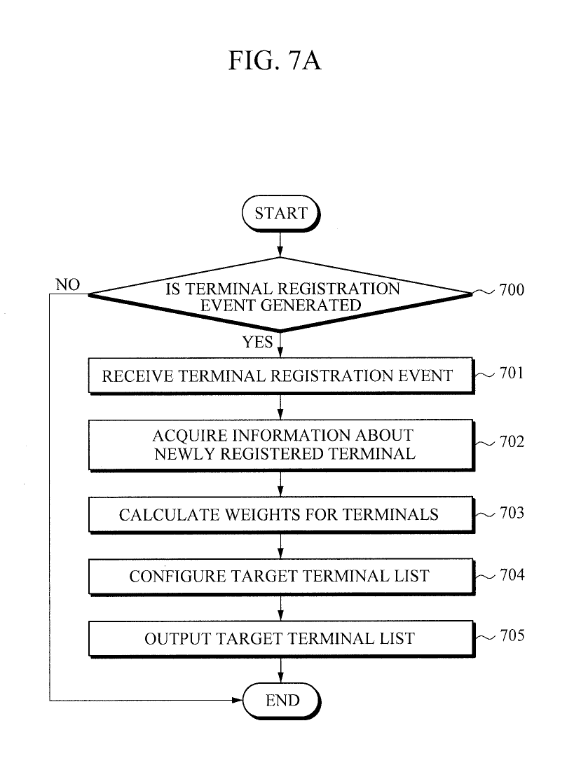

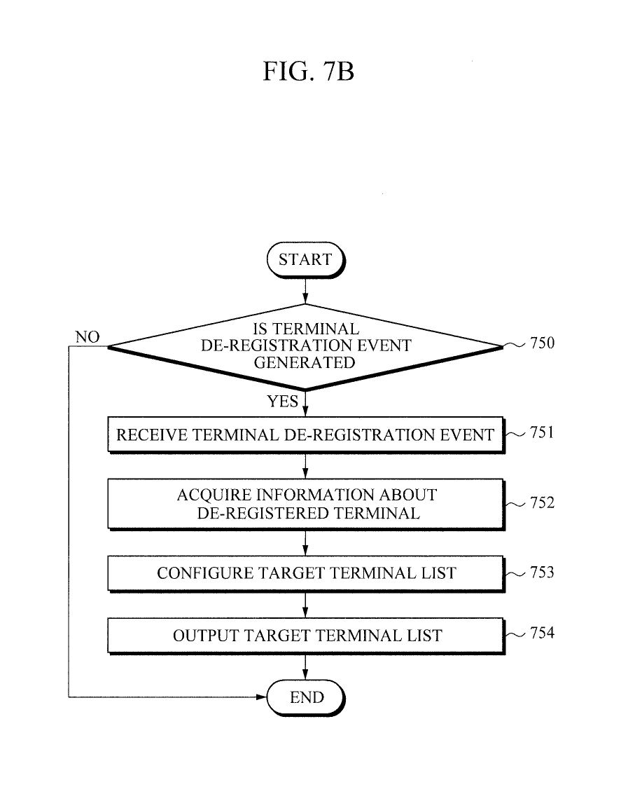

FIGS. 7A and 7B are flowcharts illustrating examples of methods of configuring a target terminal list when an event is generated while calculating weights for terminals, wherein FIG. 7A corresponds to a method of configuring a target terminal list when an event of registering a new terminal is generated, and FIG. 7B corresponds to a method of configuring a target terminal list when an event of de-registering a registered terminal is generated.

Referring to FIG. 7A, when a registration event is generated (operations 700 and 701), information about a newly registered terminal is acquired (operation 702) and included in a target terminal list. Then, weights for all terminals included in the target terminal list are calculated (operation 703) to reconfigure a target terminal list and the reconfigured target terminal list is output to the terminal in which the session is currently being executed (operations 704 and 705).

Referring to FIG. 7B, when a de-registration event is generated (operations 750 and 751), information about the de-registered terminal is deleted from an existing target terminal list (operation 752) and then the target terminal list from which the information about the de-registered terminal has been deleted is output to a terminal in which a session is currently being executed (operations 753 and 754).

When an event of registering or de-registering a terminal is generated even when a user does not request a target terminal list, the changed target terminal list may be transmitted to a terminal in which a session is currently being executed.

The processes, functions, methods and/or software described above may be recorded, stored, or fixed in one or more computer-readable storage media that include program instructions to be implemented by a computer to cause a processor to execute or perform the program instructions. The media may also include, alone or in combination with the program instructions, data files, data structures, and the like. The media and program instructions may be those specially designed and constructed, or may be of a kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as a read-only memory (ROM), a random access memory (RAM), a flash memory, and the like. Examples of program instructions include machine code, such as that produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing information about terminals allowing session mobility when a session is moved between terminals, comprising:
a terminal information manager to maintain and manage information about terminals existing on a network; and
a target terminal estimator to assign, when a session of a current terminal in which a session is currently being executed is moved to another terminal among the terminals existing on the network, weights to the terminals existing on the network based on relevancy to the current terminal using the information about the terminals, and to select a terminal to which a higher weight has been assigned as a terminal having higher possibility for session mobility.

2. The apparatus of claim 1, wherein the information about the terminals includes network information of the terminals, location information of the terminals, and information indicating that each terminal has been registered on the network or that each terminal has been de-registered from the network.

3. The apparatus of claim 1, wherein the target terminal selector comprises:
a terminal weight calculator to assign the weights to the terminals existing on the network based on the relevancy to the current terminal, using the information about the terminals; and
a target terminal list configuring unit to configure a list of target terminals to which the session of the current terminal is to be moved, according to the weights.

4. The apparatus of claim 1, further comprising:
a terminal weight DB to store, when the terminal having the higher possibility of session mobility is selected, user identification information of the terminal, network identification information of the terminal, identification information of the terminal and the weight in the form of a terminal weight table; and
a target terminal selector to provide a list of target terminals that have been determined to have high possibilities of session mobility by the target terminal estimator or a list of target terminals stored in the terminal weight DB, and to allow a user to select a target terminal to which the session of the current terminal is to be moved from the list of target terminals that have been determined to have high possibilities of session mobility or the list of target terminals stored in the terminal weight DB.

5. The apparatus of claim 2, wherein the target terminal estimator assigns the weights to the terminals,
when the terminals existing on the network have network information similar to that of the terminal in which the session is currently being executed,
when the terminals existing on the network are determined to be within a predetermined distance from the terminal in which the session is currently being executed, based on the location information of the terminals, or
when a new terminal is registered on the network.

6. The apparatus of claim 2, wherein when a new terminal is registered on the network while assigning the weights to the terminals existing on the network, the target terminal estimator assigns a weight to the newly registered terminal and then selects and provides the terminal to which the higher weight has been assigned as a terminal having higher possibility of session mobility, and when a terminal registered on the network is de-registered while assigning the weights to the terminals, deletes information about the de-registered terminal and then selects and provides the terminal to which the higher weight has been assigned as a terminal having higher possibility of session mobility.

7. The apparatus of claim 4, wherein the target terminal selector assigns the weights to the terminals existing on the network when the terminal in which the session is currently being executed requests a list of target terminals to which the session is to be moved or when a terminal weight table for the terminal in which the session is currently being executed is updated.

8. The apparatus of claim 5, wherein when a predetermined time elapses after the terminal having the high possibility of session mobility is selected, the target terminal estimator again assigns weights to the terminals existing on the network using the network information and the location information of the terminals.

9. A method of providing information about terminals allowing session mobility when a session is moved between terminals, comprising:
assigning weights to terminals existing on the network based on relevancy to a current terminal in which a session is currently being executed, using information about the current terminal and information about the terminals existing on the network;
configuring a list of target terminals by arranging the terminals to which the weights have been assigned in descending order of the weights;
providing the list of target terminals to the terminal in which the session is currently being executed; and
storing the list of target terminals in each terminal in which a session is currently being executed and again assigning weights to the terminals existing on the network when a predetermined time elapses.

10. The method of claim 9, wherein the assigning of the weights to the terminals existing on the network is performed,
when the terminals existing on the network have network information similar to that of the terminal in which the session is currently being executed,
when the terminals existing on the network are determined to be within a predetermined distance from the terminal in which the session is currently being executed, based on the location information of the terminals, or
when a new terminal is registered on the network.
